(19) United States
(12) Patent Application Publication
(10) Pub. No.: US 2005/0018432 A1
(43) Pub. Date: Jan. 27, 2005

(54) Reflector lamp with a high domed lens

(76) Inventors: Jeffrey P. Buschmann, Lexington, KY (US); Kevin R. Davies, Lexington, KY (US)

Correspondence Address: OSRAM SYLVANIA Inc., 100 Endicott Street, Danvers, MA, 01923, US

(21) Appl. No.: 10/684,945

(22) Filed: Oct. 14, 2003

Related U.S. Application Data
(60) Provisional application No. 60/490,143, filed on Jul. 25, 2003.

(51) Int. Cl. F21V 5/02

(52) U.S. Cl. 362/328; 362/329; 362/339

(57) ABSTRACT

A PAR lamp may be formed with a highly domed lens. The domed lens enables increased beam spread to as much as 90 degrees from the lamp axis. This fills in the shadow gaps between adjacent lamps. The domed lens may also extend beyond the forward edge of a recessed fixture and thereby washing the adjacent walls with light instead of leaving shadowed regions intermediate adjacent fixtures.

### CROSS-REFERENCE TO RELATED APPLICATIONS

The Applicants hereby claim the benefit of their provisional application, Ser. No. 60/490,143 filed Jul. 25, 2003 for REFLECTOR LAMP WITH A HIGH DOMED LENS.

### BACKGROUND OF THE INVENTION

1. FIELD OF THE INVENTION

The invention relates to electric lamps and particularly to PAR lamps. More particularly the invention is concerned with an electric PAR lamp with a domed lens.

2. DESCRIPTION OF THE RELATED ART INCLUDING INFORMATION DISCLOSED UNDER 37 CFR 1.97 AND 1.98

The common flood lamp, referred to more technically as a PAR lamp comprises a light source in a glass parabolic reflector. The reflector is sealed with a lens that may be flat or have a shallow curvature. The reflector commonly has a threaded base for mounting in a standard screw type socket. The reflector is designed to project light generally forward to a field to be illuminated. The covering lens may further adjust this spread. The lamp reflector and lens then set the beam spread. The largest beam spread from such lamps is thought to be about 65 degrees. A recessed lighting fixture, such as a typical ceiling fixture (“can”) has either no effect on the beam spread or it cuts off some of the beam when the lamp is recessed too far. Such lamp and fixture combinations therefore enable only at most about a 65 degrees beam spread. There is then a need for a PAR lamp with a beam angle greater than what currently exists.

Most if not all PAR lamps using press ware reflectors and lenses have beam distributions that are not optically smooth. Irregularities in the filament, reflector and lens or in their mutual coordination result in streaks, splotches or other projected light pattern defects that can be visible in the resulting beam. This is due first to the fact that the light source itself may vary from sample to sample, and is not an ideal point source. It is also due to the fact that there are irregular optical features, boundaries, labels, defects and other features formed in or on the lens or on the reflector surface. There is effort to reduce this optical “noise,” by increasing the number of reflective facets, and overlapping multiple projected images to average the beam features. Efforts to overlap images undermine the ability to spread the beam. Lens and reflector quality may also be increased, but only at increased manufacturing expense. There is then a need for a PAR lamp with a high spread angle and reduced optical noise.

A standard PAR lamp may have a flat or slightly a curved lens. This lens curvature may be quantified as the dome height or as the ratio of the dome height H relative to the plane intersecting the mounting edge to the radius R of the dome, as measured in the plane intersecting the mounting edge. Standard PAR20, PAR30, and PAR38 lenses have ratios of their axial heights to radii (H/R) as follows: PAR20=0.251 (7.97 mm/31.75 mm); PAR30=0.257 (12.24 mm/47.63 mm); and PAR38=0.203 (12.45 mm/61.21 mm) or from about one fifth to one quarter. At most, a standard PAR20 lens has an axial height equal to about one quarter of the dome radius.

### BRIEF SUMMARY OF THE INVENTION

A reflector lamp may be made with a reflective shell having a base end, a wall defining a cavity surrounding an axis extending towards a field to be illuminated. The reflector wall has an edge encircling and thereby defining a light opening leading from the defined cavity to the field to be illuminated. An electric lamp capsule is located in the defined cavity, the capsule having electric leads extending through the base end for electrical connection. A lens is sealed to the shell to cover the light opening and enclose the lamp capsule in the defined cavity, the lens having a domed structure with a maximum (outer) axial height greater than one half the maximum (outer) transverse radius. An electrical and mechanical coupling is coupled to the base end for electrical coupling of the electrical leads and mechanical support of the reflector lamp. The domed lens enables a greater spread (field angle) in the projected light. The light may also be more evenly spread.

### BRIEF DESCRIPTION OF THE SEVERAL VIEWS OF THE DRAWINGS

FIG. 1 shows a cross sectional view of a prior art PAR lamp lens.

FIG. 2 shows a cross sectional view of a domed PAR lamp with a smooth frosted lens.

FIG. 3 shows an exploded view of a domed PAR lamp with a facetted lens.

FIG. 4 shows a beam spread chart of a prior art PAR lamp.

FIG. 5 shows a beam spread chart of a domed PAR lamp.

FIG. 6 shows a schematic view of a domed PAR lamp mounted in a recessed fixture.

FIG. 7 shows a cross sectional view of a domed PAR lamp lens with a continuous lens feature.

FIG. 8 shows a cross sectional view of a domed PAR lamp lens with Fresnel optical features.

FIG. 9 shows a cross sectional view of a domed PAR lamp lens with ribbed optical features.

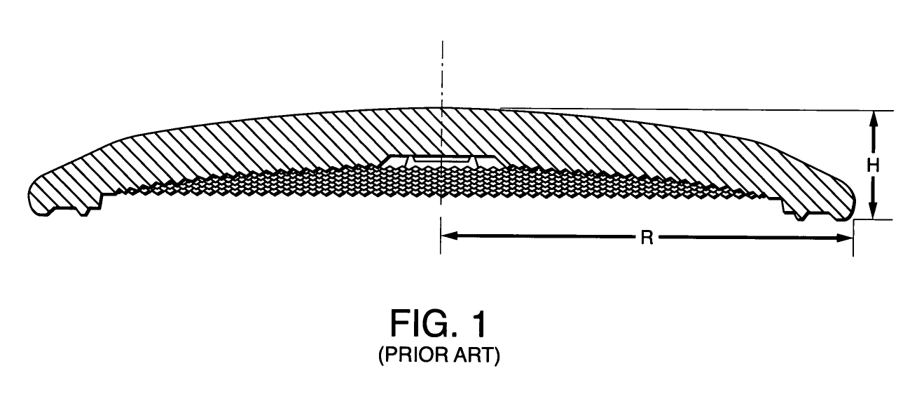

### DETAILED DESCRIPTION OF THE INVENTION

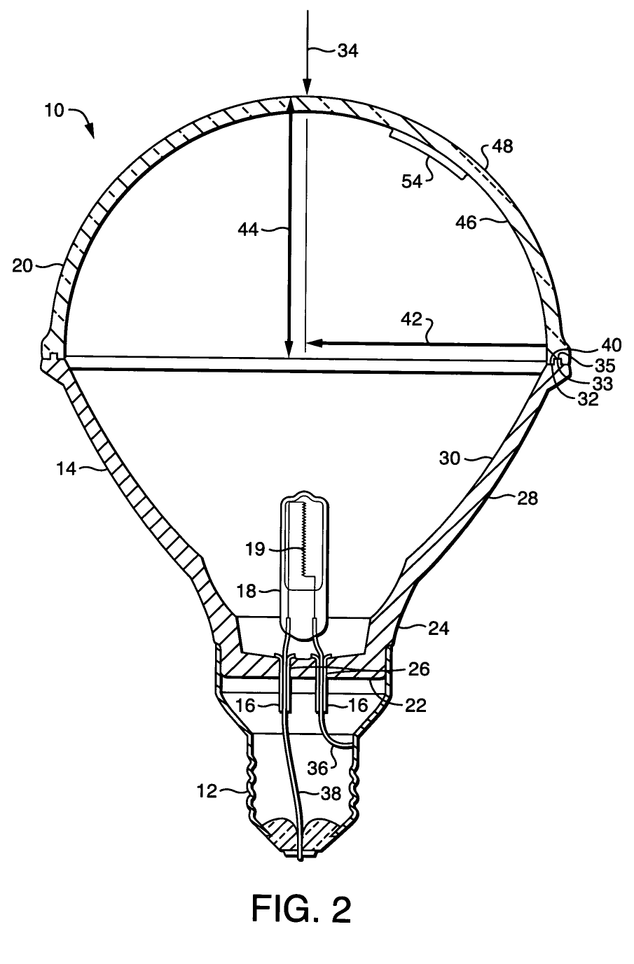

FIG. 2 shows a cross sectional view of a domed par lamp 10. The preferred domed par lamp 10 comprises a threaded base 12, a molded glass reflector 14, eyelets 16, a lamp capsule 18 and a domed lens 20

The threaded base 12 may be one typical of standard lamps, and may be made of brass, aluminum or other materials. A threaded base 12 is not required and the invention here may be used in conjunction with a bayonet, pin base or any other convenient coupling for mounting a lamp in a socket. The threaded base 12 is preferred for downward suspension from a ceiling socket.

The preferred reflector is a molded glass reflector 14 that has a base wall 22, and a neck region 24 that couples in the base 12. The base wall 22 may be formed with one or more through passages 26 that provide electrical access to the enclosed lamp capsule 18. The Applicants mold indentations (dimples) in the neck region 24 into which a portion of the base 12 may be pressed or peened to form a firm attachment. Glues, and other convenient methods may be used to mount the base 12 to the reflector 14. The reflector 14 has a wall 28 that defines an internal reflective surface 30. The Applicants prefer a parabolic reflective surface 30, as the manufacture of such reflector units already exists, and is well understood. Hyperbolic and elliptical or other reflective surface shapes of revolution may be used. The reflector surface 30 may segmented into include subsections (facets, panels, etc.) for beam blending purposes as is known the art. The preferred reflective surface 30 is aluminized for high reflection as is known in the art. Other reflective surface materials may also be used, for example dichroic coatings. The reflector 14 has a forward edge 32 designed to support the domed lens 20. Various couplings between reflectors and lenses are known in the art. The preferred coupling is an outward facing tongue 33 that may be mated, for example by glue to an inward facing groove 35 of the domed lens 20. Matched steps, face to face, threaded, splined, and similar coupling structures may also be used to mate the reflector 14 and the lens 20. The reflector 14 and the domed lens 20 may also be flame sealed as is known in the art. The reflector 14 may similarly include facets and other light dispersing features in the reflective surface 30 as is know in the art.

A frosted domed lens 20 provides excellent filament image blending and light dispersion results. The reflector 14 may then be less expensively made as a simple smooth surfaced parabola of rotation. In the alternative the reflector 14 may have a reflective surface 30 that is a section of an ellipse of rotation. The near focal point may be placed at or near the location of the light source. The second focal point may be placed at or near the reflector and lens axis 34, and in or near the plane of the reflector edge 32 and lens rim 40 coupling. In these ways the light from the light source (filament 19) either directly or by reflection encounters the steep sides of the domed lens 20 and is refracted sharply to the side, away from the axis 34 thereby giving a large and even beam spread. By incorporating a frost, a coating or similar feature to the domed lens inner surface 46, the light may be dispersed both widely and evenly. In the preferred embodiment, the domed lens 20, or a substantial portion of the domed lens 20 extends beyond the standard recessed lighting fixture depth. The domed lens 20 may then project exteriorly from a fixture recess, and may direct light to the sides of the lamp 10 to fill in otherwise dark areas intermediate lamps recessed in sequential fixtures. Light is of course similarly dispersed to the sides when used with no recessed type fixture.

In the preferred embodiment, mounted to reflector 14 are eyelets 16 extending through the passages 26 of base wall base wall 22. The eyelets 16 may be brass tubes with rolled ends that fit snuggly in the through passages 26.

The preferred lamp capsule 18 is a tungsten halogen lamp with a filament 19, a press sealed base and two protruding leads 36, 38. The leads 36, 38 are extended into the eyelets 16 for secure electrical connection and mechanical support. The eyelets 16 and the leads 36, 38 may be soldiered, or similarly electrically and mechanically coupled together. The lamp capsule 18 may be any convenient light source, whether incandescent, discharge, solid-state or any other electrical light source. The preferred position of the lamp capsule 18 is with respect to the optical features designed in the reflector. For the preferred parabolic reflector 14, the filament 19 of the preferred tungsten halogen lamp capsule is position to be axially aligned with the filament 19 overlapping the focal point for the preferred parabolic surface of the reflector 14.

The domed lens 20 has a rim 40 that mates to the reflector 14 along forward edge 32. The preferred domed lens 20 is substantially a body of revolution with a radius 42 in the plane of the rim 40, and an axial height 44 measured perpendicular to the plane of the rim 40 to the highest external point of the domed lens 20. The dome height 44 is greater than one half the lens radius 42 and preferably equal to (hemispherical) or greater than (semi-ovoid) the lens radius 42. It is understood that the domed lens 20 may be further elongated so that the axial height 44 is greater than one times the dome's radius. The domed lens 20 may be substantially elongated with no theoretical limit on the axial height 44 to radius 42 ratio. For practicality, the ratio of the axial height 44 to radius 42 ratio is likely limited to about 3.0. The degree of doming may then range from 0.50 to 3.0. The preferred axial height 44 is 1.0 giving a hemispherically domed lens.

The domed lens 20 inner surface 46 and outer surface 48 are preferably smooth. Either or both may include facets, Fresnel ribbings, lenticules or other refractive optical features as may be convenient and as are know in the art. The inner surface 46 and the outer surface 48 of the domed lens 20 may have differing rates of curvature, thereby creating an additional lens feature to refract the light. For example, the region near the rim 40 may be thicker 50 than the region near the crown 52 (axial top), resulting in refraction away from the axis 34. The domed lens 20 may optionally include a coating 54, or surface treatment, for example a color filter layer, dichroic coating, frosting, etching, metallization or similar coating as known in the art. The preferred domed lens 20 for a smooth parabolic reflector 14 incorporates an inside frost to diffuse the light.

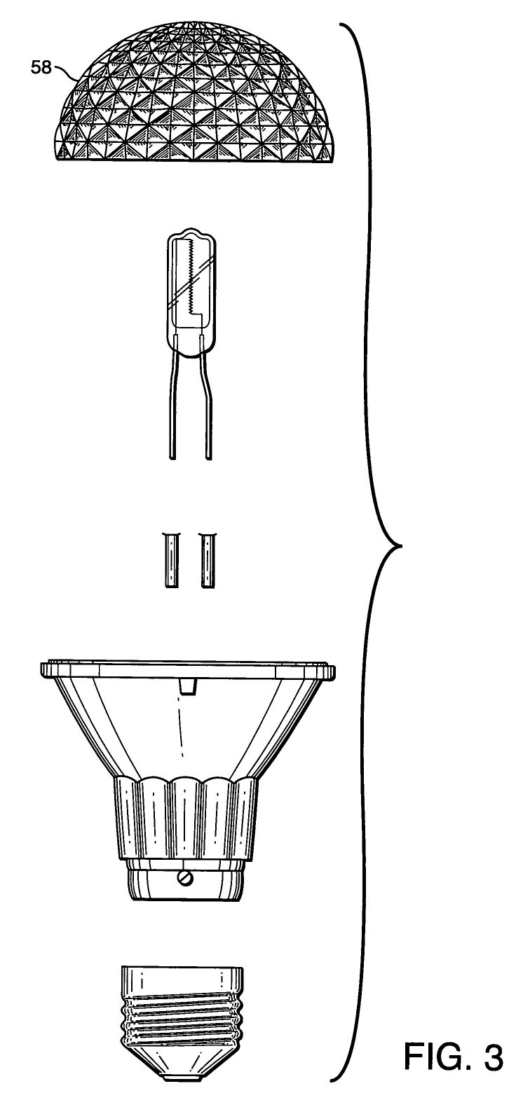

FIG. 3 shows an exploded view of a domed PAR lamp with a facetted lens 58.

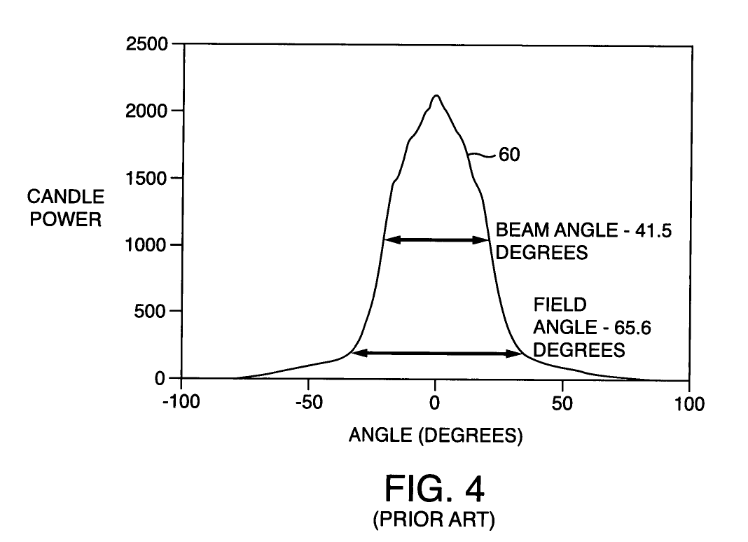

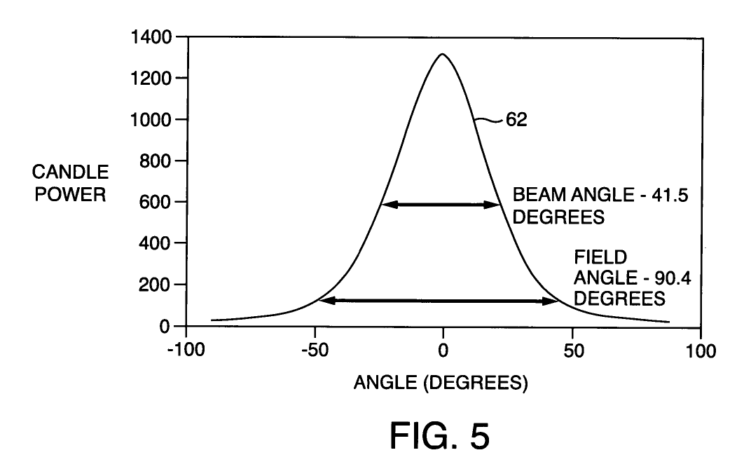

FIG. 4 shows a beam spread chart of a prior art PAR lamp. The chart shows the amount of light 60 projected by a standard PAR lamp at different angles from the lamp axis. The standard beam angle is about 41.5 degrees. The standard field angle is about 65.6 degrees. These are fairly representative of what is currently available in PAR type reflector lamps. The beam pattern can be seen to be somewhat irregular. FIG. 5 shows a similar beam spread chart of a smooth, frosted domed lens PAR lamp. Again the chart shows the amount of light 62 projected by the domed lens reflector lamp at different angles from the lamp axis. The beam angle is also 41.5 degrees, while the field angle is 90.4 degrees, showing the substantial increase in spreading the light to the sides by the domed lens. The beam pattern is also very smooth with no intensity bumps.

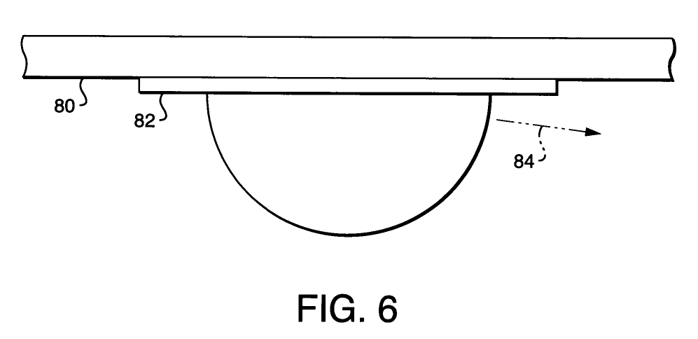

FIG. 6 shows a schematic view of a domed PAR lamp mounted in a recessed (ceiling) lighting fixture. The domed lens 20 may extend beyond the plane of a standard fixture opening. As shown, the domed lens 20 extends almost as a hemisphere beyond the plane of the ceiling 80 and the fixture 82. Light 84 may then be brought around the corner defined by the fixture opening.

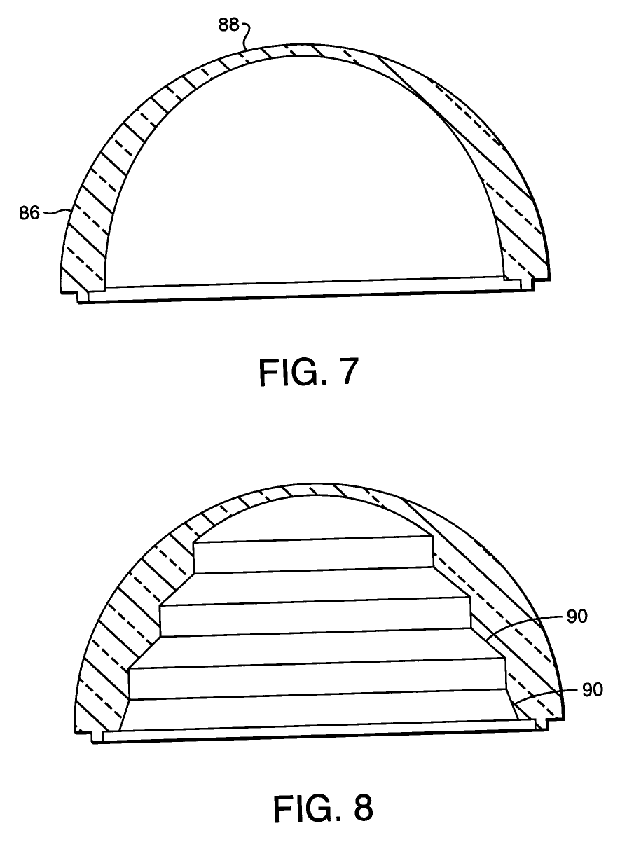

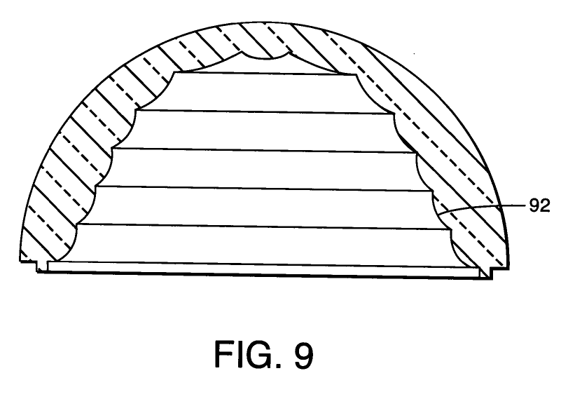

FIG. 7 shows a cross sectional view of a domed PAR lamp lens with a continuous lens feature. The wall at the rim 86 is thicker than the wall at the crown. with a continuous variation inbetween to provide a smooth optical lens. FIG. 8 shows a cross sectional view of a domed PAR lamp lens with Fresnel optical features 90. The Fresnel elements 90 extend around the domed lens in bands transverse to the dome axis. FIG. 9 shows a cross sectional view of a domed PAR lamp lens with ribbed optical features. The ribs 92 extend around the domed lens in bands transverse to the dome axis.

While there have been shown and described what are at present considered to be the preferred embodiments of the invention, it will be apparent to those skilled in the art that various changes and modifications can be made herein without departing from the scope of the invention defined by the appended claims.

1. A reflector lamp comprising:
a reflective shell having a base end, a wall defining a cavity surrounding an axis extending towards a field to be illuminated, the wall having an edge encircling and thereby defining a light opening leading from the defined cavity generally towards the field to be illuminated;
an electric lamp capsule located in the defined cavity, the capsule having electric leads extending through the base end for electrical connection;
a lens sealed to the shell to cover the light opening and enclose the lamp capsule in the defined cavity, the lens having a domed structure with a maximum (outer) axial height greater than one half the maximum (outer) transverse radius; and
an electrical and mechanical coupling coupled to the base end for electrical coupling of the electrical leads and mechanical support of the reflector lamp.

2. The reflector lamp in claim 1, wherein the lens is approximately hemispherical.

3. The reflector lamp in claim 1, wherein the reflective shell is at least partially metallized to reflect light from the lamp capsule in the direction of the defined opening.

4. The reflector lamp in claim 1, wherein the lens is clear.

5. The reflector lamp in claim 1, wherein the lens is translucent.

6. The reflector lamp in claim 1, wherein the lens is faceted.

7. The reflector lamp in claim 1, wherein the lens includes coaxial circular lens elements.

8. The reflector lamp in claim 1, wherein the reflector has an interior surface defining a section of a parabola of revolution.

9. The reflector lamp in claim 1, wherein the reflector has an interior surface defining a section of an ellipse of revolution.

10. The reflector lamp in claim 1, wherein the reflector has an interior surface with light dispersing facets.

11. The reflector lamp in claim 1, wherein axial distance from the base end to the edge is approximately equal to a standard interior axial distance from a socket to a fixture opening, whereby the domed lens extends substantially beyond the fixture opening.
